(19) United States
(12) Patent Application Publication
(10) Pub. No.: US 2009/0089260 A1
(43) Pub. Date: Apr. 2, 2009

(54) Quick Searching UI for a Better User Experience

(76) Inventors: Benedict T. CHONG, San Jose, CA (US); Victor E. CHIN, San Jose, CA (US); Thomas DENG, Cupertino, CA (US); Philip SHEU, San Jose, CA (US); Mark M. LEE, Saratoga, CA (US); Ching-Yi Lin, Taipei (TW); Jian-Jung Shiu, Taipei (TW); Ching-Yang Wu, Taipei (TW); Chia-Cheng Wong, Taipei (TW); Wen-Pin Tsai, Taipei (TW); Chun-Ming Tsao, Taipei (TW)

Correspondence Address: GLENN PATENT GROUP, 3475 EDISON WAY, SUITE L, MENLO PARK, CA, 94025, US

(21) Appl. No.: 12/239,687

(22) Filed: Sep. 26, 2008

Related U.S. Application Data
(60) Provisional application No. 60/975,724, filed on Sep. 27, 2007.

(51) Int. Cl. G06F 17/30; G06F 3/048; G06Q 20/00

(52) U.S. Cl. 707/3; 715/843; 715/765; 705/40; 707/E17.014; 707/E17.101

(57) ABSTRACT

A Quick Search User Interface (UI) comprises a search entry field for inputting characters, e.g. search terms. The Quick Search UI further comprises icons that are graphical representations of applications. The Quick Search UI subsequently launches an operating system and passes the user action to the operating system. The operating system uses this information to generate search results comprising websites, program files, videos, etc. Alternatively, the operating system launches the application(s) selected by the user. Icons displayed on the user interface are ordered, for example, according to a company's willingness to pay more money for a more prominent spot or according to user preferences. The Quick Search UI can be customized using skins with themes, such as musicians, geographic locations, and/or products. The icons can be displayed according to which application provider pays the highest premium, or according to user preference.

### CROSS REFERENCE TO RELATED APPLICATIONS

This patent application claims the benefit of U.S. provisional patent application Ser. No. 60/975,724, Quick Searching Facility for Virtualized Environment, filed Sep. 27, 2007, the entirety of which is incorporated herein by this reference thereto.

### BACKGROUND OF THE INVENTION

1. Technical Field

This invention relates generally to the field of personal computers. More specifically, this invention relates to performing quick searches.

2. Description of the Related Art

When a computer is powered on, the computer loads a basic input output system (BIOS), which is a boot loader that loads the operating system (OS) for the computer. The OS is a host for all the application programs that run on the computer. The booting process can take several minutes to complete.

Computer users are impatient. This phenomenon is best illustrated by the common observation that if a webpage does not load within a certain number of seconds, a user frequently gives up and tries to load another website. Users want instant access to their computers mere seconds after they press the power button.

U.S. Publication No. 2007/0157115 discloses a command prompt where a user can type in instructions to launch an application instead of locating an icon to launch the application. This process, however, still requires that the OS load, and therefore only saves the time it takes to locate an icon for the application.

In response to increased consumer impatience, virtualization platforms were developed for generating a user interface that allows users to selectively choose applications, thereby avoiding the time consuming process of loading all applications. Splashtop™ software, for example, allows users to access applications such as the Internet two to five seconds after activating the computer. In addition to providing users with instant gratification, Splashtop™ software is a more energy-efficient method for using a computer because it obviates the need for hibernation or sleep mode, both of which needlessly drain energy.

Once users have quick access to applications, they can still be overwhelmed by a seemingly limitless amount of data. Thus, various methods of searching are provided to narrow a user's options. For example, Google® Desktop (U.S. Pat. No. 7,272,601) provides a search engine for searching the Internet for keywords input by a user. In addition, Google® Desktop also searches the user's client, i.e. a local computer and other computers or servers connected by a network, for articles associated with those keywords, e.g. word processing documents, previously viewed web pages, etc.

Mozilla provides a search bar for its Firefox web browser that simultaneously searches other search engines such as Google®, Yahoo®, Amazon®, eBay®, Answers.com®, and Creative Commons. This browser, however, still requires loading Windows and does not search for items on a user's computer.

### SUMMARY OF THE INVENTION

In one embodiment, a Quick Search User Interface (UI) comprising a search entry field launches before the OS is active. The user takes action, e.g. inputs search items into the search entry field, presses a key, selects an icon, etc. The Quick Search UI launches the OS and passes details of the user action to the OS. The OS executes the requested action. For websites and YouTube videos, for example, the OS launches a web browser with the search items and the web browser returns the search results. If the text items are related to a particular application, e.g. a Skype handle, the OS launches the application and passes the text items to the OS as parameters. In this example, the Skype application will call the contact matching the Skype handle.

In another embodiment, the user specifies which application to launch by entering specific terms into a search entry field. In one embodiment, icons represent an application. An application is either running binary code on the local machine, e.g. Microsoft Word, or the application is a web site or web property, e.g. Google Maps, Facebook, Adobe Photoshop Express. The icons are displayed on the UI and ordered either according to the company willing to pay the most money for that spot or according to user preferences. In another embodiment, the Quick Search UI is customized, e.g. by displaying icons that are selected by a user, that are paid for by the service providers, by customizing the display with skins, i.e. customized graphical appearances.

In another embodiment, the Quick Search UI is part of an appliance that runs in a virtual appliance environment (VAE). The VAE uses an embedded OS instead of the host OS to launch virtual appliances (VA). The VAs are stored locally or are downloaded from the Internet, e.g. an appliance server.

### BRIEF DESCRIPTION OF THE DRAWINGS

FIG. 1 is a block diagram that illustrates a system for implementing a Quick Search User Interface according to one embodiment of the invention;

FIG. 2 is a block diagram that illustrates one embodiment of a system for implementing a Quick Search User Interface according to the invention;

FIG. 3 is an example of a Quick Search User Interface according to one embodiment of the invention;

FIG. 4 is an example of search results that are obtained for the search term “jewel” according to one embodiment of the invention;

FIG. 5 is an example of a Quick Search User Interface that displays a drop down menu for selecting an application according to one embodiment of the invention; and

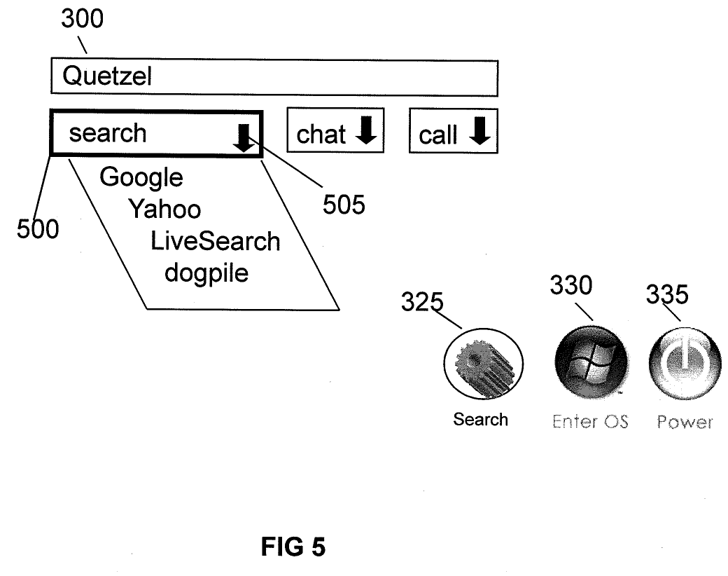

FIG. 6 is a flowchart that illustrates the steps for performing a search using the Quick Search User Interface according to one embodiment of the invention

### DETAILED DESCRIPTION OF THE INVENTION

In one embodiment, the invention comprises a method and/or an apparatus to quickly present a user interface (UI) that allows the user to enter parameters to perform searches or initiate other actions before the operating system (OS) is active. In another embodiment of the invention, the Quick Search UI displays icons associated with applications that, when selected, pass instructions to the OS, which in turn, launches the application.

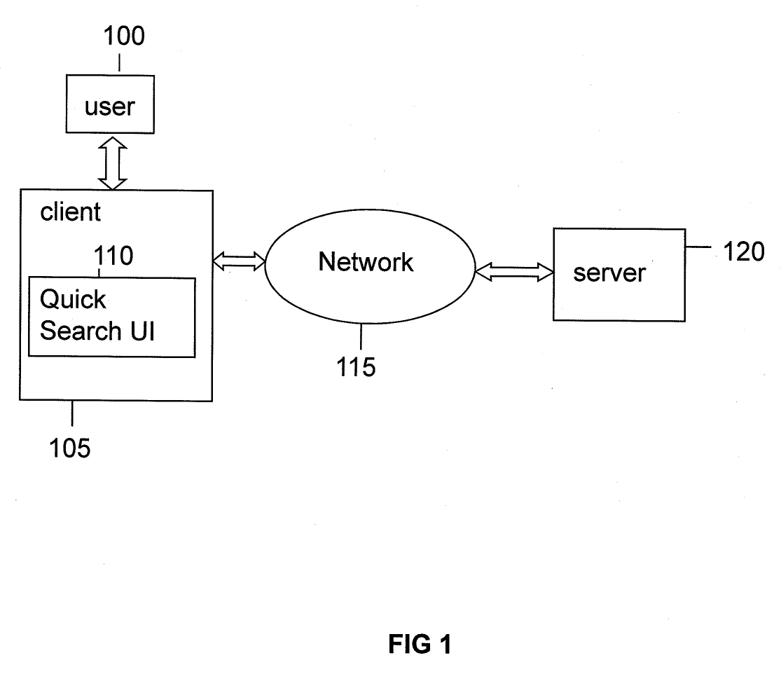

FIG. 1 is a block diagram that illustrates a system for implementing the Quick Search UI 110. A user 100 uses a client 105, e.g. a computing platform configured to act as a client device such as a computer, a digital media player, a personal digital assistant, or a cellular telephone, containing the Quick Search UI 110. The user 100 activates the client 105, which launches the Quick Search UI 110. The client 105 communicates with a server 120, e.g. a computing platform configured to act as a server, over the network 115, e.g. a local area network (LAN), a wide area network (WAN), a home network, the Internet.

In one embodiment, the network 115 is implemented via wireless and/or wired solutions. The server 120 is illustrated as comprising one computing platform but, in other instances, the system comprises multiple computer platforms that act in concert.

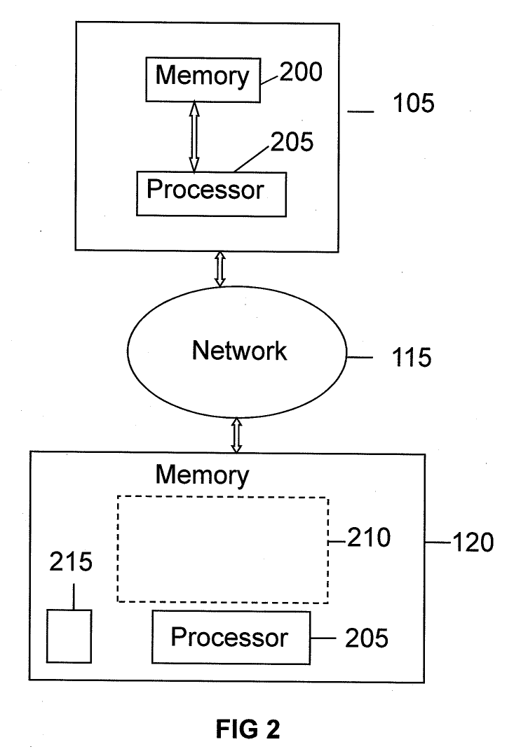

FIG. 2 is a simplified diagram illustrating an exemplary architecture in which the system for using a Quick Search UI 110 is implemented. The exemplary architecture includes a client 105, a server 120 device, and a network 115 that connects the client 105 to the server 120. The client 105 is configured to include a computer-readable medium 200, such as random access memory (RAM) or magnetic or optical media, coupled to an electronic processor 205. The processor 205 executes program instructions stored in the computer-readable medium 200.

The server 120 device includes a processor 205 coupled to a computer-readable medium 210. In one embodiment, the server 120 device includes a secondary data storage element, such as a database 215.

In one embodiment, the client 105 contains, in part, the customized application. Additionally, the client 105 and the server 120 are configured to receive and transmit electronic messages for use with the customized application.

One or more user applications are stored in memories 200, in memory 210, or a single user application is stored in part in one memory 200 and in part in another memory 210.

### Quick Search User Interface (UI)

The Quick Search UI is loaded in a pre-boot environment. Thus, the UI is displayed mere seconds after a user powers up the computer. By comparison, if a user were to use Windows to perform a search, the user would have to wait several minutes for the BIOS to load the Windows OS and the user would then have to select an application to perform the search, e.g. Internet Explorer.

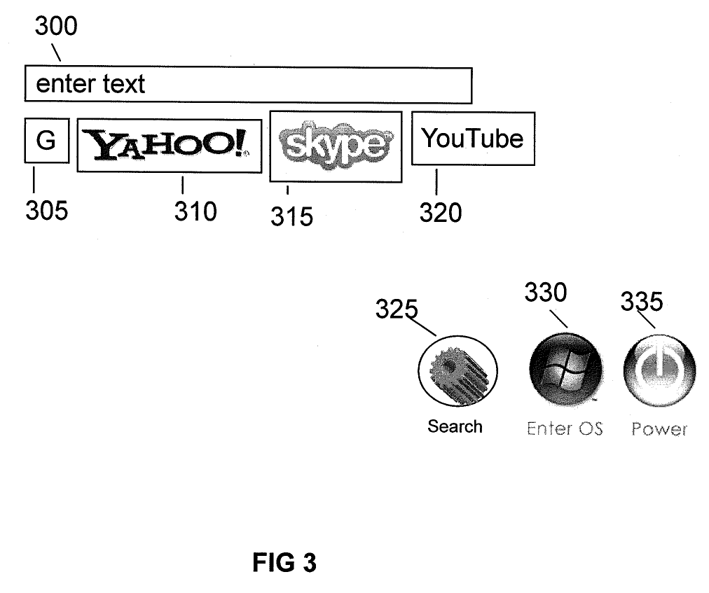

FIG. 3 is an example of a Quick Search UI according to one embodiment of the invention. A user enters text into the search entry field 300 comprising a query.

In one embodiment, the search entry field 300 accepts any of Roman characters, non-Roman characters, e.g. Greek, Cyrillic, or ideographic constructs e.g. Chinese, Japanese, Korean, etc.

The user searches a specific application for the search terms, e.g. Google® 305, Yahoo® 310, Skype® 315, or YouTube® 320. In one embodiment, the applications include a program that provides maps or driving directions, a voice over internet protocol (VoIP) application other than Skype®, an instant messenger, a program for online shopping, stock quotes, music players, video players, a program for displaying digital photographs, and/or a calendar. In one embodiment, the calendar is personalized and includes agenda items for a specific user.

For example, a user types the word “jewel” into the search entry field 300 and selects the YouTube® application 320. The YouTube application launches and returns a list of videos performed by the artist Jewel. The user entering a phone number and clicking on the Skype® 315 icon initiates a call using the entered phone number. A user could also enter a contact's handle and press the Skype® 415 icon. Similarly, a user could enter the handle into the search entry field 300 and click on an instant messaging icon to initiate contact with that user. In another embodiment, the user accesses applications by typing the name of the application into the search entry field 300. For example, typing “Word” into the search entry field launches the Microsoft Word® application. In this embodiment, Quick Search UI launches Windows to access Microsoft Word®.

Instead of clicking on an icon for a particular application, the user can also use an identifier to indicate the type of application to search. For example, the identifier for searching YouTube for a Jewel video could be “[YT] Jewel,” or a user could enter a NASDAQ symbol to obtain a stock quote. If a user wanted to know if there are any plans on the user's personal calendar for the weekend, the user could specify that the calendar be launched to allow the user to type in the date in question.

A user can obtain driving directions by entering a “;” or “;;” or some other intuitive separator mechanism to distinguish between the “to” and “from” addresses that are compatible with all search tools and search content types. For example, if a user wanted driving directions from the user's home to DeviceVM's San Jose office, the user could enter into the search entry field 300: “101 Marigold Dr., Palo Alto, Calif.;; 1054 South De Anza Blvd., San Jose, Calif.”

An embodiment of the Quick Search UI performs intelligent guessing on a search string to determine which application to launch. Thus, a user could simply type a URL into the search entry field, which is recognized by the Quick Search UI as a command to load a browser with the URL. The Quick Search UI then launches the OS with instructions to the OS to launch a browser loaded with the URL. The Quick Search UI can recognize that numbers are phone numbers, an address is meant to be mapped, etc. This facilitates an uncluttered UI. Furthermore, it increases the value of any icons present on the page because the user is not overwhelmed with icons.

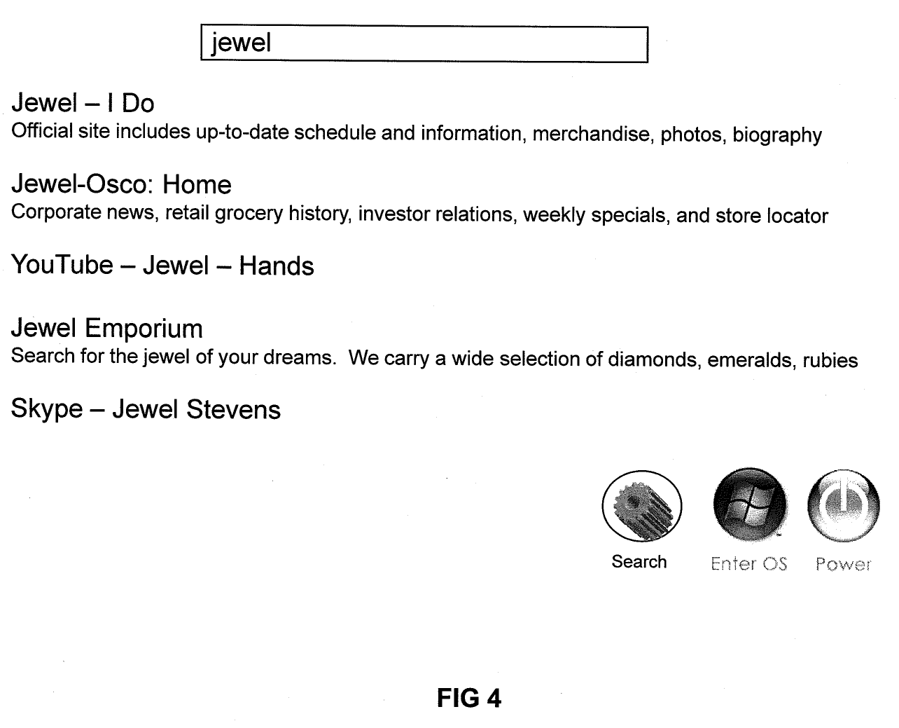

Alternatively, the user can select a search button 325 to obtain a list of all search results. FIG. 4 is an example of using the search term Jewel, which results in obtaining Jewel the artist's webpage, the webpage for Jewel-Osco, a YouTube video of Jewel performing “Hands,” a website for purchasing jewels, and the handle for a user's contact—Jewel Stevens.

Instead of entering a query into the search entry field 300, the user can click on one of the icons to launch an application. For example, when the user clicks on a Google® maps icon, the Google® maps application is loaded. The user can then enter an address directly into the application.

The user can select the Windows icon 330 to load the default OS. The user can select the power icon 335 to power-down the computer. The toolbar can also contain other icons such as a reboot icon, a volume control icon, or a network advanced configuration for a proxy server, static IP setup, etc.

In another embodiment, the icon represents a type of application. FIG. 4 is an example of a Quick Search UI with a drop down menu. In this embodiment, the user clicks on a drop-down menu to select a specific type of browser search application or tool. Here, the user can select from various search engines, e.g. Google®, Yahoo®, LiveSearch®, dogpile, by selecting the arrow 505 in the search icon 500.

In one embodiment, the Quick Search UI or the subsequently-running OS pre-fetches and caches the results for frequently searched terms, search terms that a user previously searched, or search results that a user is likely to search based on the user's profile. If a user enters one of the stored search terms, the search results are returned without accessing the Internet, thereby providing search results faster. The search results can be ordered according to relevance, frequency, or another ordering system known to a person of skill in the art. In one embodiment, the search entry field suggests search terms to a user based on a few letters entered into the search entry field using pre-fetched and cached search terms. In another embodiment, the Quick Search UI or subsequently-running OS pre-fetches and caches a number of popular websites or the last websites visited by a user.

### Interaction Between the Quick Search UI and the OS

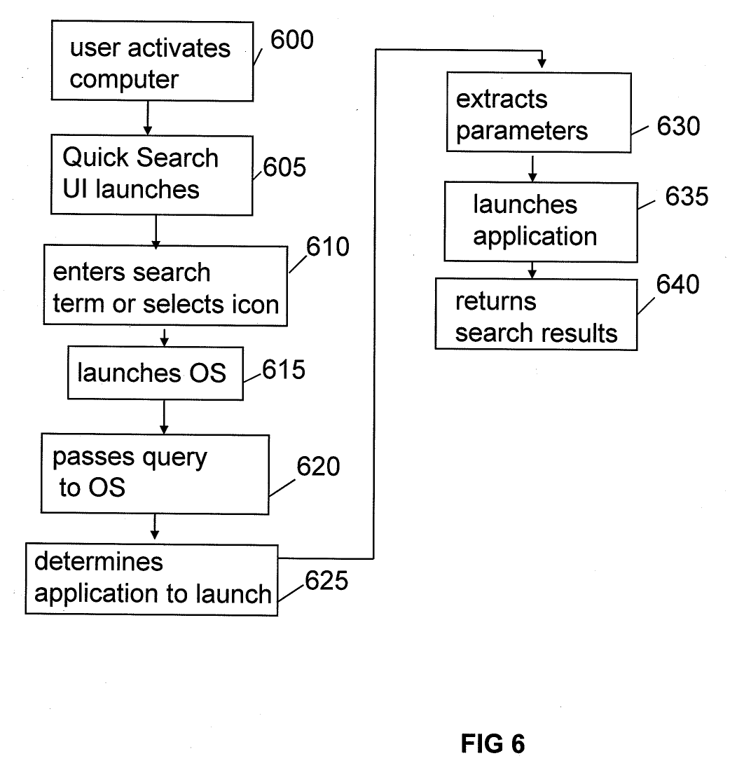

FIG. 6 is a flow chart that illustrates the steps for using the Quick Search UI. The user activates 600 the computer by pressing the power button, or alternatively, by pressing a hotkey. The Quick Search UI is launched 605. The user enters 610 characters into the search entry field and/or selects 610 an icon. The Quick Search UI launches 615 the OS. The OS can be either the default OS, e.g. Windows or an alternative OS, e.g. Linux or a Splashtop™ program. The Quick Search UI passes 620 the information to the OS. If the OS is a Linux-based environment, the Quick Search UI passes the information to the Linux kernel or startup scripts.

A start-up script determines 625 which application should be launched and extracts 630 the parameters for the application. If the search employs the Google® search engine, for example, the OS uses the Firefox command-line to pass the search text. The search value can also be passed through a shared file or global variable that is parsed on startup.

The OS launches 635 the appropriate application based on which icon the user clicked and any identifiers provided in the search entry field. The application returns 640 the search results if the user requested a search.

### Monetization

The Quick Search UI provides several monetization opportunities. First, application providers can pay a fee to have their icon displayed on the UI. See, for example, FIG. 3 application icons for Google® 305, Yahoo® 310, Skype® 315, YouTube® 320. The fee can vary according to the position of the icon, i.e. the first position is the most expensive because customers are more likely to use the first icon that they see. The order of the icons can change when a subscription expires. For example, if a company pays for a one month subscription to display its instant messaging icon first, the next month that icon is replaced by an icon for another subscriber. The order of the icons can be altered through updates to the Quick Search UI, for example, via the Internet.

Alternatively, the icons are displayed for free, but a fee is charged each time a user selects a particular application or clicks on a link to that application (click-through). This monetization system is compatible with a UI that allows users to customize the icons by defining which icons appear, the order of the icons, etc.

In addition, a search engine provider could pay a fee to have its search engine defined as the default search engine.

In one embodiment, an application provider pays for an exclusivity contract. In this case, for example, a company pays so that only a single search engine icon is provided on the Quick Search UI.

In another embodiment, banner advertisements are displayed on the UI. The number of banner advertisements are limited only by the available space on the UI and aesthetic concerns. For example, too many banner advertisements displayed on the UI create a cluttered environment and decrease the value of each advertisement.

In one embodiment, the stored search results for common search terms are displayed according to the highest bid offered for each slot. For example, if a common search term is car and BMW® bids for the top slot, even though Mercedes® may be a more relevant search result according to the user's profile, BMW® is displayed first.

The Quick Search UI can be personalized according to a particular theme, called a skin. These skins include, for example, a background graphic, customized icons for the applications, or even a customized on-screen mouse cursor. For example, a skin for Guitar Hero® can be a background of a guitar, icons of guitar hero characters or different musical instruments could represent the applications, and the on-screen mouse cursor could be displayed as a musical note. If the skin is a theme of Miley Cyrus, the background could be pictures of Miley Cyrus. These pictures could be similar to a calendar in that they change every day, week, or month.

In one embodiment, users pay a subscription fee for a particular skin. Alternatively, because the skins are considered free advertising, a company pays to have a skin for one of their products, artist, etc. displayed to the user via the UI.

### Localization

In one embodiment, the Quick Search UI determines the user's location, e.g. by querying the server, or with other mechanisms such as a global positioning system (GPS), etc. Thus, the user is not prompted for the location. Furthermore, the applications can be region specific. For example, the common search engine in Europe is eZilon, but in the United States Google's® search engine is the most popular. Thus, in one embodiment, when a user loads the Quick Search UI, enters text, and clicks on the search engine icon in Europe, instead of at the user's residence in the U.S., the subsequently-running OS automatically launches a search using eZilon instead of a more common U.S. search engine, e.g. Yahoo®.

In another embodiment, the Quick Search UI accepts different characters in response to the location of the computer. For example, if the computer is located in the U.S., the Quick Search UI accepts Roman characters. If the computer is in Eastern Europe, the Quick Search UI accepts Cyrillic characters.

### Hardware

In one embodiment, the Quick Search UI accesses the following pieces of hardware: a video controller, mouse, keyboard, on-screen mouse cursor, and hard disk controller. The hard disk controller allows the CPU to communicate with a disk drive that contains the code for running the Quick Search UI.

The OS that runs the applications can be any OS, such as Windows or Linux, which uses the same pieces of hardware as the Quick Search UI. In addition, the OS can use a network controller, CDROM or DVD interface, audio, and a USB or memory card interface. The network controller can be wired or wireless. The CDROM or DVD interface can be used, for example, for music and video playback appliances. The USB or memory card interface can be used, for example, for photo and music applications.

### Virtual Appliance Environment (VAE)

In one embodiment, the Quick Search UI runs on a VAE, which is an embedded OS, i.e. a secondary OS that is included in the system boot ROM or on other storage media of a personal computer. Splashtop™ software, manufactured by DeviceVM of San Jose, Calif. is one example of a Linux-based VAE. The VAE is included in the system boot ROM of a personal computer. The VAE quickly boots up and installs the necessary drivers for network access and a graphics display of the Quick Search UI.

In this embodiment, the applications can be virtual appliances (VA), which are self-contained software applications. The Quick Search UI is one type of VA. The different variations for implementing a VA are described in U.S. patent application Ser. No. 11/772,700, filed Jul. 2, 2007 (Attorney Docket No. DEVM0004), the contents of which are herein incorporated in their entirety by this reference thereto.

The Quick Search UI displays any available VA from, for example, but not limited to any of the following places: local USB, dongle, flash card, e.g. SD, xD, CF, CDROM/DVD, or other storage media; local hard disk storage; and the Internet, e.g. an appliance server. The user selects an appliance to use from a list displayed on the UI. The appliance is loaded and launched. If the selected appliance is not on local storage, then it is downloaded, e.g. from a local network, a virtual private network (VPN), or over the Internet from an appliance server. In one embodiment, the downloaded appliance is cached in local storage media such that, the next time it is needed, it need not be downloaded from the appliance server.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following claims.

1. A computer system comprising:
a display device;
a user interface comprising:
a search entry field for accepting input of at least one character; and
at least one icon, said icon comprising a graphical representation of an application for display on said display device, said application comprising any of a program running binary code and a website;
a processor to execute program instructions for launching an operating system and passing program instructions to said operating system in response to said at least one character being entered into said search entry field or in response to said at least one icon being selected for launching of said application; and
said operating system for carrying out instructions received from said user interface.

2. The computer system of claim 1, wherein said operating system is inactive until launched in response to input received by said user interface.

3. The computer system of claim 1, wherein said at least one icon comprises a drop-down menu comprising a plurality of graphical representations of applications for activation.

4. The computer system of claim 1, further comprising:
means for displaying said at least one icon in accordance with payment by an application provider as a fee.

5. The computer system of claim 4, wherein a plurality of icons are displayed according to a hierarchical fee structure.

6. The computer system of claim 1, said system further comprising:
a virtual appliance environment,
wherein said operating system is an embedded operating system.

7. The computer system of claim 6, wherein said virtual appliance is a self-contained software application stored on at least one of a local storage device and an appliance server.

8. The computer system of claim 1, further comprising:
a script on said operating system for determining that said application is to be launched and for extracting a plurality of parameters for launching said application.

9. The computer system of claim 1, wherein said application comprises any of a search engine, browser, instant messaging application, music player, video player, voice over internet protocol application, and calendar application.

10. The computer system of claim 1, wherein said application provides any of a map, driving directions, a video, a music track, a photograph, a website, stock quotes, and a calendar.

11. The computer system of claim 1, further comprising a means for pre-fetching and caching at least one query for offline searching of a search engine.

12. The computer system of claim 1, wherein said user interface further comprises a skin for personalizing said display.

13. The computer system of claim 12, wherein said skin is displayed in accordance with payment by an appliance provider as a fee.

14. A computer implemented method for inputting at least one character into a user interface before an operating system is launched, comprising the steps of:
suspending said operating system;
launching a user interface, said user interface stored on at least one computer, said user interface comprising a search entry field and at least one icon, said icon comprising a graphical representation of an application;
receiving at least one character entered into said search entry field;
launching an operating system;
passing said at least one character to said operating system; and
launching said application in response to receiving said at least one character.

15. The method of claim 14, further comprising the step of:
searching said application with said at least one character; and
returning a search result.

16. The method of claim 14, further comprising the step of:
determining from said at least one character said application for launching.

17. The method of claim 14, further comprising:
searching a plurality of applications; and
returning at least one search result from said plurality of applications.

18. The method of claim 17, further comprising:
pre-fetching at least one search result;
caching said at least one search result; and
returning said at least one search result offline when said search is for said cached search result.

19. A computer readable medium comprising program code for executing the method of claim 14.

20. The computer readable medium of claim 19, wherein said program code is stored on at least one of a local universal serial bus, a flash card, a hard disk, and an appliance server.
